(19) United States
(12) Patent Application Publication
(10) Pub. No.: US 2026/0332932 A1
(43) Pub. Date: Oct. 22, 2026

(54) Modular Charger for Hearing Aids

(71) Applicant: SONOVA AG, Staefa (CH)

(72) Inventors: Maximilian Rose, Staefa (CH); Simon Laternser, Staefa (CH); Michael Eckardt, Stäfa (CH); Thomas Knoblauch, Rapperswil-Jona (CH); Matthias Riepenhoff, Hombrechtikon (CH)

(21) Appl. No.: 19/468,309

(22) Filed: Feb. 3, 2026

(30) Foreign Application Priority Data
Feb. 5, 2025 (EP) 25156051.2

(51) Int. Cl. H04R 1/1025; H02J 7/34; H02J 7/70

(52) U.S. Cl. CPC H04R 1/1025; H02J 7/342; H02J 7/731

(57) ABSTRACT

A charger for electrically recharging a battery of a hearing device, comprising a charger casing with a basic body portion and a first lid. An electronics module is inserted into the first compartment and comprises a power management circuitry and a charging circuitry. The electronics module comprises a second compartment that is configured to receive a first portion of the hearing device, which first portion of the hearing device is configured to receive the electric power from the power transfer elements in an operating state of the charger. The basic body portion of the charger casing comprises a third compartment that is sized such that it can accommodate a second portion of the hearing device in a space-saving manner in an operating state of the charger.

### RELATED APPLICATIONS

The present application claims priority to EP Patent Application No. 25156051.2, filed Feb. 5, 2025, which is hereby incorporated by reference in its entirety.

### BACKGROUND INFORMATION

Hearing devices are often fitted with rechargeable batteries and need to be recharged either using wireless charging or contact-based charging of the rechargeable batteries using charging terminals, while the batteries remain in the hearing device. Several chargers are known that have a compartment with first power transfer elements that is dedicated to receiving a first portion of the hearing device fitted with second power transfer elements that are designed to receive electric power from the first power transfer elements.

Popular types of hearing devices are Receiver-In-Canal (RIC) type hearing devices or so-called Behind-the-Ear (BTE) hearing devices. Both types have a so-called BTE-part that comprises all the electronics for compensating the hearing loss of the end user and is worn behind the head and the ear/pinna, whereas the content of the BTE-part differs from one type to the other. What is common between both types is that the BTE-part is connected to a sound delivery system which ends in the ear canal of the end user in an operating state of the hearing device. There are basically two species of sound delivery systems known.

In a first species of a sound delivery system, the BTE-part is connected via a sound tube which guides the sound emitted by a receiver in the BTE-part to the ear drum. Typically, there is a dome or a custom shell or the like to position the end of the sound tube in the ear canal to satisfy comfort and audiological needs.

In a second species a sound delivery system, the BTE-part is connected via cables with a receiver that is positioned in the ear canal such that sound is emitted towards the ear drum. Typically, there is a dome or a custom shell or the like to position the end of the sound tube in the ear canal to satisfy comfort and audiological needs. There is a variety of domes known in the art. An exemplary dome is made of a silicone material and has a spherical portion that seals off the ear canal towards the environment at least in part, and a coupling portion provided to couple the dome to the receiver.

As to the custom shells, their overall size depends on how deep they fit in the ear as well as on other factors.

The selection of the hearing device type that suits an end user depends on factors like the hearing loss, aesthetic preferences, lifestyle needs, and budget. Most commonly in binaural hearing systems with a hearing device for the left-ear and the right-ear, such chargers have a compartment for receiving the first portion of the hearing device, i.e., the BTE-part, each. CH718984A2 and EP3518560B1 are representatives of chargers. The sound delivery system can be stowed away by the end user in a cavity of the charger. That cavity is coverable by a first lid of the charger such that the hearing devices are protected from undesired environmental impacts when the charger is carried in a bag or the like from one place to the other. That cavity normally extends over the entire width of the charger. Up to now, it was common to design a charger for hearing devices that can receive both types of hearing devices, regardless of whether their sound delivery system had an end piece (e.g., a dome or a custom shell) that was dimensionally bulky or compact and regardless of whether the BTE-part was compact or bulky in dimensions. In addition, the first species of the sound delivery system with the sound tube is bulkier than the second species of the sound delivery system with the cable connection and the receiver. As a result, one typically ended up with a charger that was comparatively bulky in its overall dimensions since there was a one-fits-all approach for the charger. If a hearing device had a comparatively compact sound delivery system and/or a comparatively compact BTE-part, that compromise that did not always meet the end user desire to have a dimensionally compact charger.

Although it would be theoretically possible to tailor each charger to the dimensions of the hearing device such that a charger having the smallest overall dimensions possible results, such an approach is economically disadvantageous. That is why the producers of hearing systems often offered just the one-fits-all charger.

### BRIEF DESCRIPTION OF THE DRAWINGS

Below, embodiments are described in more detail with reference to the attached drawings.

FIG. 1 shows a first embodiment of a charger, wherein the electronics module is not inserted into the first compartment of the charger casing, yet;

FIG. 2 shows a three-dimensional view of the electronics module shown in FIG. 1;

FIG. 3 shows a schematic view about the main contents of the electronics module shown in FIG. 1;

FIG. 4 shows a view onto the bottom side of the charger of FIG. 1;

FIG. 5 shows a three-dimensional view into the charger casing of FIG. 1, wherein the electronics module is not inserted into the first compartment of the charger casing, yet;

FIG. 6 shows the charger casing of FIG. 5, wherein the electronics module is inserted into the first compartment of the charger casing;

FIG. 7 shows the same charger as shown in FIG. 6, wherein a first pair of BTE hearing devices is placed with its BTE-part portion into the second compartment and wherein the sound delivery system with the cable and the xReceiver is placed into the third compartment;

FIG. 8 shows a second embodiment of a charger, wherein the electronics module is not inserted into the first compartment of the charger casing, yet;

FIG. 9 shows the charger of FIG. 8, wherein the electronics module is inserted into the first compartment of the charger casing; and

FIG. 10 shows the same charger as shown in FIG. 9, wherein a second pair of BTE hearing devices is placed into the second compartment and wherein the sound delivery system with the cable and the custom shells is placed into the third compartment.

### DETAILED DESCRIPTION

Described herein are chargers for charging hearing devices with electric power.

There is an ongoing desire for an economic solution for chargers that are suitable for a variety of hearing device types and sizes, and whose overall charger dimension is still comparatively compact. There is further a desire to enhance the charger such that it allows an adaption to changed needs of the end user over time, for example if the end user needs different hearing devices but wants to continue using the charger.

Therefore, the present document aims at promoting a solution that meets the above desire and allows a tailoring of the charger to the hearing device such that the overall dimensions of the charger can still be kept compact while the economic factors are still considered.

In a most basic embodiment of the inventive charger, the charger for electrically recharging a battery of at least one hearing device comprises the following:
a charger casing with a basic body portion and a first lid. The first lid conceals a first compartment provided in the basic body portion at least in part in a closed position of the first lid.
an electronics module that is inserted into the first compartment, wherein the electronics module comprises a power management circuitry and a charging circuitry that functionally connects power transfer elements provided in the charger to transfer electric power from a power source to the battery located in the hearing device. The power management circuitry and a charging circuitry can be combined in one submodule, for example located on the same printed circuit, where required. The electronics module comprises a second compartment that is configured to receive a first portion of the hearing device, which first portion of the hearing device is configured to receive the electric power from the power transfer elements in an operating state of the charger. In other words, that first portion of the hearing device is formed by a portion of the BTE-part of the hearing device.

In a basic form, the power source is formed by the residential power grid to which the charger is connectable in a common way, for example by way of a USB-C cable or the like.

The basic body portion of the charger casing comprises a third compartment that is sized such that it can accommodate a second portion of the hearing device in a space-saving manner at least in an operating state of the charger. The second portion of the hearing device comprises a major portion of the sound delivery system, regardless of the species.

An particularly beneficial embodiment of a charger with respect to a cleaning of the third compartment form debris or ear wax residues is achievable if the third compartment has an interior contour whose edges are chamfered or rounded with an as large as possible radius. The term “space-saving manner” is understood such that the end user can stow the second portion of the hearing device effortlessly into the second compartment. That second compartment is sized and shaped such that it can just accommodate the second portion of the hearing devices without wasting too much excessive room. Expressed in other words, the features described herein allow for tailoring the overall size of the charger by selecting an optimal size and shape of the second compartment and thus the charger casing to the second portion of the hearing device to be received. In case of a RIC with a connector cable and an external receiver (also known as xReceiver), the second compartment can be smaller in size than in case of a RIC with a connector cable and custom shells that are known to be bulkier than the external receiver, for example. Tests revealed that the third compartment can easily be between 1.5 and 3.5 times as large as the first compartment to cover the entire range of hearing device types and species.

The second compartment does not need to be that big that it can receive most of the BTE-part. It is sufficient, if the second compartment is sized and formed such that it can hold the BTE-part of the hearing devices reliably in their optimal position while charging the hearing devices.

The power management circuitry and the charging circuitry form the most expensive parts in a charger. Allocating these elements in an electronics module forms a smart module which is insertable both in larger sized charger casings as well as in smaller sized charger casings depending on the size of the hearing device to be stowed away in the charger. Separating that more expensive smart module from the charger casing allows together with the allocation of the most expensive electronic components in the electronics module to keep the charger casing with no or at least with low intelligence only. In an embodiment, the rechargeable power source in the form of a rechargeable battery is also allocated in the electronics module such that the charger casing can be kept completely without any electronic parts. All of this is beneficial since it allows for having a set of differently sized basic body portions that are all designed with the same first compartment and to receive the same type or at least the same sized electronics module. The differently sized basic body portions lead to differently sized chargers, eventually.

Another benefit of such a charger resides in that in case of an electronic defect somewhere in the charger, a hearing care professional (HCP) or someone else can only exchange the electronics module while keeping the charger casing. That unlocks a charger design that contributes to a reduction of electronic device waste. Another benefit of such a charger resides in that in case the end user changes her/his hearing aids, or changing from xReceivers to earmolds, only the charger casing can be exchanged while keeping the same electronic module.

In a most basic embodiment, the electronics module is just held in the basic body portion such that it is not falling out of the basic body portion if the first lid is open, and the end user holds the charger upside down.

If it shall be allowed to exchange the charger casing, the electronics module is designed such that it is extractable from the first compartment. Such an embodiment also allows swapping the electronics module to a differently colored charger casing or the like for fashion or other reasons.

In a most basic embodiment, the power transfer elements are located on a wall section of the first compartment, typically at the bottom of the first compartment. In a more advanced embodiment, the power transfer elements are located on an interim element like an insert in a more advanced embodiment. In an example of such a latter embodiment, the casing comprises inserts that are shaped and sized to receive the first portion of the hearing device, while the inserts are attached to the charger casing via a form-fit connection, in some examples. In such an embodiment, the power transfer elements are part of the inserts, while allowing a smart galvanic connection to the electronics module.

To enable a charging of the hearing devices also while the charger is not connected to a residential power grid, the power source may be built-in the charger. In an exemplary embodiment, the power source is a rechargeable power source that is configured to electrically charge a battery located in the hearing device in an operating state of the charger. The rechargeable power source is commonly known as a rechargeable battery. The circuitry of the charger shall be such that the end user can charge her/his hearing devices also in case the rechargeable battery is defect if she/he connects the charger to the residential power grid. In such a case, the battery will be bypassed by the current flowing through the charging circuitry.

If the power source of the charger needs to be replaceable for meeting laws or for other reasons like reducing waste or allowing for a repair of a defect charger by the end user, for example, the power source is arranged in a fourth compartment provided in the basic body portion. The basic body portion has a second lid arranged at its base portion that conceals the fourth compartment at least in part in a closed state of the second lid. If needed, the second lid can be configured such that it holds the power source, for example a rechargeable battery in place when the second lid is closed. Alternative embodiments are conceivable, where the second lid just covers the user's view onto the power source and/or protects the rechargeable battery from undesired environmental impacts while the power source is held tightly in the fourth compartment by other means, for example by known spring-contacts. If the end user shall be prevented from accessing the power source of the charger easily, the second lid can require a tool like a coin, a screwdriver or the like to open and retract it.

A solution for a second lid that requires no hinge resides in that the second lid is configured as a sliding lid. In that case, the basic body portion has at its bottom portion some groove or guide geometry that engages with a corresponding geometry of the second lid. Where required, for example to improve the system security or the like, the power management circuitry and/or the charging circuitry can detect whether the first lid is open or closed. That can be done via a magnet and a sensor detecting the proximity of a magnet.

Since the power source of the charger is rechargeable, it needs to be connected to a domestic power grid every now and then. To establish such a connection, the power source is electrically chargeable via a first charging terminal of the charger that is, in some examples, accessible from outside the charger casing for simplicity. Depending on the desired solution, the first charging terminal can be a socket or a plug or even an inductive charging unit.

As mentioned already earlier on, the charger can have a rechargeable power source that is also allocated in the electronics module such that the charger casing can be kept completely without any electronic parts. Such an embodiment is particularly advantageous since one could have a variety of differently sized charger casings that are all designed with the same first compartment and to receive the same type or at least the same sized electronics module.

To avoid an intermediate terminal to which the grid side is connectable and to which the electronics module is connected, we promote an embodiment where the first charging terminal is provided in the electronics module such that it is accessible from outside the charger casing through a dedicated opening provided in a wall of the basic body portion of the charger casing.

In embodiments of the charger where the power source in the form of a rechargeable battery is not integrated into the electronics module but located in the basic body portion of the charger casing, for example a charger casing with a basic body portion having a fourth compartment, a galvanic connection between the power source and the electronics module is achievable in that a second charging terminal is located at a bottom portion of the first compartment such that it electrically connects reliably with corresponding battery contact terminals located at the bottom of the electronics module once the electronic module reaches its designated end position when inserting the electronics module into the first compartment.

A convenient embodiment of the first lid is formed by a hinged lid. Film hinges are flexible and thin-walled hinges made of the same material as the two fixed components it connects.

That hinged lid can be a separate element or a film hinge that connects the first lid to the basic body portion. As a feature integrated into the first lid and the basic body portion, the film hinge allows an easy opening and closing of the first lid. However, compared to other lids, film hinges allow the production of complete parts in one injection molding process.

The power management circuitry and/or the charging circuitry can detect whether the first lid is open or closed. That can be done via a magnet and a sensor detecting the proximity of a magnet.

In an alternative embodiment of the charger, the first lid is attached to the electronics module. Such an embodiment might be beneficial for running pre-assembly tests for chargers whose closing position of the first lid is detected electronically.

Again, the power management circuitry and/or the charging circuitry can detect whether the first lid is open or closed. That can be done via a magnet and a sensor detecting the proximity of a magnet.

If it is desired that the end user cannot access the interior of the charger, the electronics module is best locked within the basic body portion after its insertion into the first compartment such that it is not falling out of the basic body portion unintentionally when the charger is positioned upside down and with the first lid open. A side benefit resides in that the end user is prevented from touching an active electronic circuit when the power source of the charger is charged. Yet another advantage resides in that it is possible to keep an outer shell surface of the electronic module comparatively open, such as an electronic rack, because there is no need to protect the end user from an electric shock in such an embodiment. There are several geometries available to achieve such a lock mechanism, for example by a snap-fit connection with a hook or an orifice and a nose that engages with that hook or nose tightly.

A charger whose volume of the third compartment is at least as large as the volume of the second compartment suffices typically for the connector cable and an external receiver (xReceiver) of a RIC device.

A charger whose volume of the third compartment is at least 1.5 times as large as a volume of the second compartment suffices typically for stowing away the second species of a sound delivery system having a connector cable and a small custom shell portion of a RIC device. If the custom shell is larger, the volume of the third compartment can be up to 3.5 times as large or even larger than the volume of the second compartment.

If an undesired jamming of the connector cables or the sound tube in the second compartment shall be avoided already at the time of inserting the first portion of the hearing device into the second compartment, it is recommendable to provide a wall in the charger casing, whereas the wall separates the first compartment from the third compartment. That wall also eases the insertion of the electronics module into the first compartment in that is serves as an insertion guide.

In an embodiment, the charger is a special charger of a HCP. The charger comprises a charger casing with an array of first compartments. Such an embodiment was beneficial in that it offers the HCP various charging opportunities for multiple different hearing device types in a compact form in one go.

The skilled reader will recognize that some of the above-mentioned embodiments can be combined with one another to arrive at a particularly desired embodiment.

These and other aspects will be apparent from and elucidated with reference to the embodiments described hereinafter.

The reference characters used in the drawings are explained hereinafter, where required. Identical and functionally identic items are given the same or at least similar reference characters in the figures.

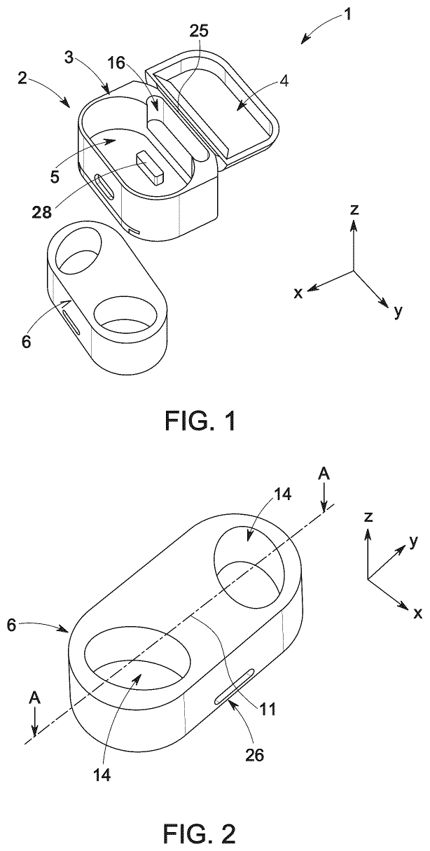

FIG. 1 depicts a charger 1 charger for electrically recharging a battery of a hearing device. The charger comprises a charger casing 2 and an electronics module 6.

The charger casing 2 comprises a basic body portion 3 and a first lid 4. The lid is connected to the basic body portion 3 by way of a hinge 25.

Since the electronics module 6 is not inserted into the charger casing yet, one can see the interior of the open charger casing 2 very well. Said casing comprises a comparatively large first compartment 5 and a comparatively small third compartment 16. There is no full wall that separates the first compartments from the third compartment at this stage.

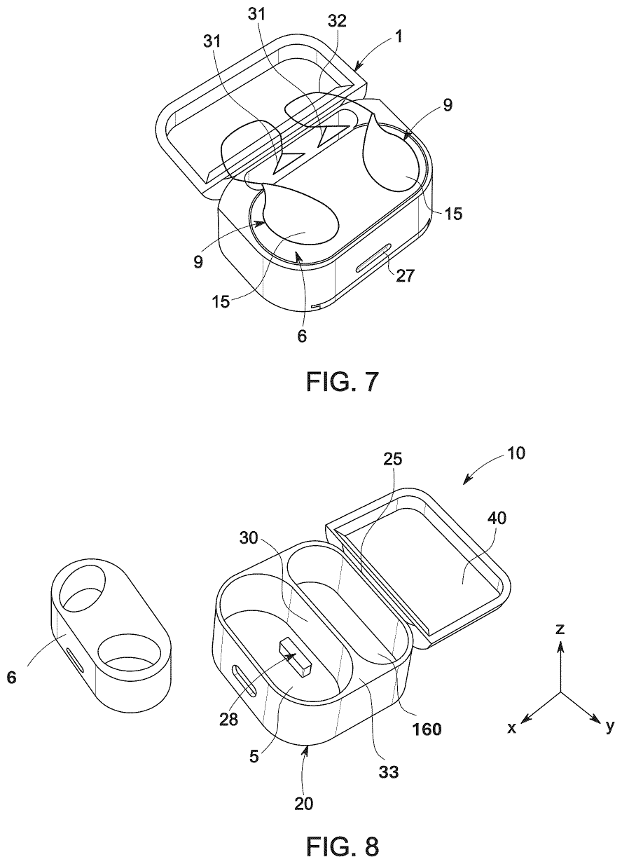

As shown from another angle in FIG. 2, the electronics module 6 comprises a two-parted second compartment 14 such that a pocket for receiving the first portion of the hearing device 9, i.e., a substantial portion of the BTE-part 15 (see FIG. 7) is formed, each. The wall portion of the second compartment 14 is integrated into the electronics module 6. The electronics module 6 has a shell surface that is configured to engage snugly and in a form-fit manner with the first compartment such that the electronics module 6 is insertable easily into the first compartment 5.

A first charging terminal 26 is provided at a side surface of the shell surface extending in the Y-Z plane of the electronics module 6. The first charging terminal 26 is allocated such on the electronics module 6 that its relative position to a dedicated opening 27 provided in a wall of the basic body portion of the charger casing such that the end user can access the first charging terminal 26 from outside the charger casing 2 through the dedicated opening 27 for connecting the charger to an external power source such as a domestic power grid (also see FIG. 7 for this feature). The first charging terminal 26 can be a USB-C socket.

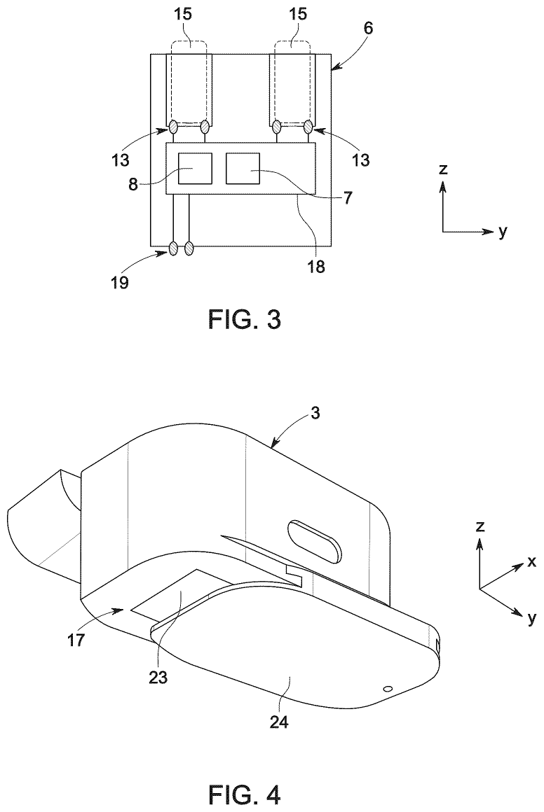

The schematic view about the main contents of the electronics module 6 shown in FIG. 3 is a sectional view along A-A in a plane extending in the Y-Z direction and reveals that the electronics module 6 comprises the following exemplary embodiment:
a power management circuitry 7 and a charging circuitry 8 that are provided in a common electronic submodule 18, e.g., even on the same PCB.
power transfer elements 13 located at the bottom of the pocket-shaped second compartment 2. These power transfer elements 13 are provided in the charger to transfer electric power from the power source 23 to the battery of the hearing devices 9, once the first portion of the hearing devices 15 (shown in dashed mode) is inserted into the pockets of the second compartment such that second power transfer elements (not shown) allocated on the first portion of the hearing devices 15 establishes a galvanic contact to the power transfer elements 13 and is ready for charging the hearing devices.
The power transfer elements 13 are galvanically connected to the electronic submodule 18 and comprise at least a supply and a ground potential. A third contact for establishing a bidirectional communication between the hearing device and the charger can be provided, if required.
On the end face of the electronics module 6 facing away from the second compartment 14, there are battery contact terminals 19 provided to establish an automatic galvanic contact to the power source in the form of a rechargeable battery located in the basic body portion once the electronics module 6 is inserted into the first compartment and reaching its designated end position in the Z-direction.

In case that the power source is integrated into the electronics module 6 (not shown), the battery contact terminals are not required any longer since the battery is galvanically connected to the electronics submodule 18 by internal wires or an electric equivalent.

FIG. 4 shows the charger 1 shown in FIGS. 1 to 2 by a view onto the bottom side of the charger. In this embodiment, a fourth compartment 17 is provided for receiving the power source 23 in the form of a rechargeable battery. A second lid 24 is formed as a slider lid and engages in grooves extending in the Y-direction along the bottom edges of the basic body portion 3. The rechargeable battery is held in the fourth compartment 17 and is galvanically connected to the battery contact terminals 19 of the electronics module by spring contact elements (not shown).

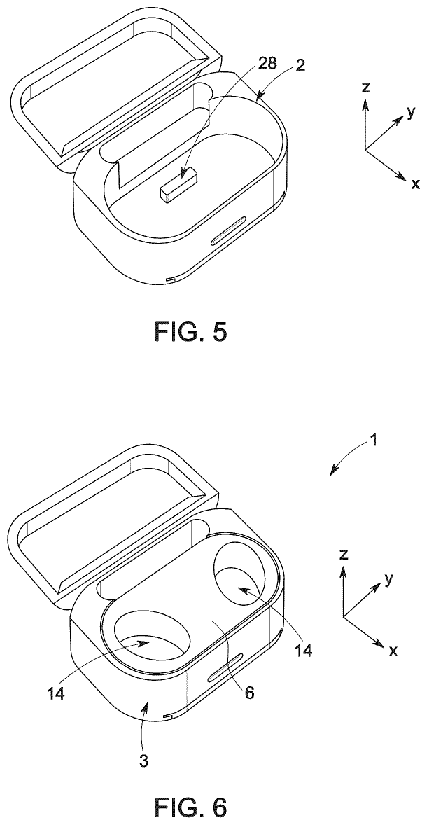

FIG. 5 differs to FIG. 1 in that it shows that a second charging terminal 28 is located at the bottom of the first compartment 5 such that it automatically establishes a galvanic contact with the battery contact terminals 19 once the electronics module 6 is inserted into the first compartment 5 and reaching its designated end position in the Z-direction.

FIG. 6 shows the same charger 1 as shown in FIG. 1 but this time the electronics module 6 is fully inserted into the first compartment 5 of the charger casing 2. As one can see, the third compartment with the elongated oval cross-section extending in the X-Y direction is delimited in the direction of the X-axis by the shell surface of the electronics module 6 extending in the Y-Z direction. At least one nose-like protrusion may be provided on the shell surface of the electronics module 6 that engages in a corresponding recess located in the basic body portion 3 to lock the electronics module 6 in the basic body portion 3.

FIG. 7 reveals schematically, how the end user can stow away the RIC type hearing devices with cables best. The external receivers (xReceivers) belonging to the second portion of the hearing device fit into the third compartment 16 while remaining electrically connected via connector cables 32 with their first portion of the hearing device 15 (BTE-parts) of the hearing devices 9.

FIG. 8 shows a second embodiment of a charger 10 in the same way as the first embodiment of the charger 1 shown in FIG. 1. The electronics module 6 of this embodiment is the very same as the one shown in the first embodiment shown in FIG. 1. The same holds true for the position and the function of the second charging terminal 28 accordingly. What is different to the first embodiment of the charger 1 shown in FIG. 1 is the size of the third compartment 160 in its extension in the X-direction. As a result of that bigger size of the third compartment 160, the entire charger casing 20 with its basic body portion 33 as well as the first lid 40 get larger in the X-direction. As a result, the overall dimension of the second embodiment of a charger 10 shown in FIG. 8 is larger than the overall dimension of the first embodiment of the charger 1 shown in FIG. 1 in the X-direction. Such an embodiment is particularly suitable for storing hearing devices whose sound delivery comprises a custom shell.

Contrary to the first embodiment of the charger 1 shown in FIG. 1, the charger casing 20 comprises a wall 30 extending in the Y-Z direction that separates the first compartment 5 from the third compartment 160. That wall 30 helps guiding the sound delivery system as easy as possible from the BTE-part to the third compartment 160.

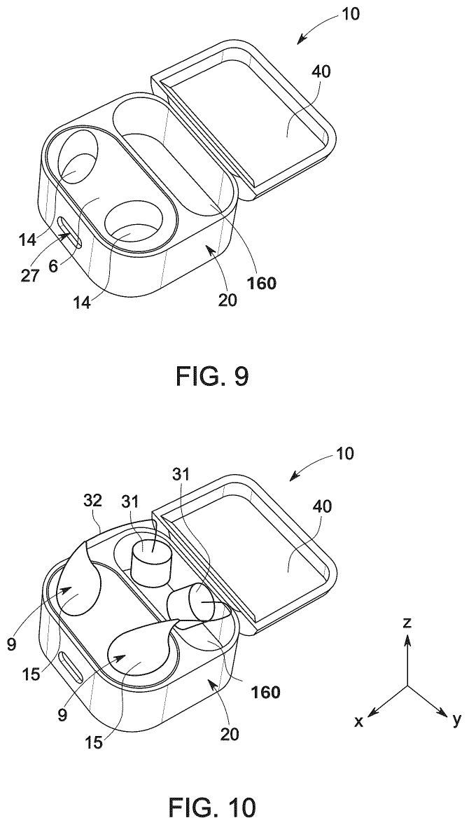

FIG. 9 shows the second embodiment of the charger 10 shown in FIG. 8 similar to the way shown in FIG. 6, where the electronics module 6 is fully inserted into the first compartment 5 of the charger casing 20.

The situation regarding the location and the accessibility of the first charging terminal remains unchanged compared to the first embodiment of the charger 1.

FIG. 10 shows the second embodiment of the charger 10 shown in FIGS. 8 and 9 similar to the way shown in FIG. 6. As can be seen, the custom shell earpieces 31 that are connected via connector cables 32 to their first portion of the hearing device 15 (BTE-parts) of the hearing devices 9. Since the size of the custom shell earpieces 31 shown very schematically in FIG. 10 is bigger than that of the external receivers (xReceivers) shown in FIG. 7, the end user is glad to have a bigger sized third compartment 160 to stow them away safely such that he can close the first lid.

### LIST OF REFERENCE SYMBOLS

1, 10 charger with electronics module before insertion into the basic body portion
2, 20 charger casing
3, 33 basic body portion
4, 40 first lid
5 first compartment
6 electronics module
7 power management circuitry
8 charging circuitry
9 hearing device
11 lateral axis (y-axis)
13 power transfer elements
14 second compartment
15 first portion of the hearing device (BTE-part)
16, 160 third compartment
17 fourth compartment
18 electronic submodule
19 battery contact terminals
23 power source/battery
24 second lid
25 hinge
26 first charging terminal
27 opening in the wall of the basic body portion
28 second charging terminal
30 wall between the first and the third compartment
31 second portion of the hearing device (sound delivery system)
32 connector cable

What is claimed is:

1. A charger for electrically recharging a battery of a hearing device, wherein the charger comprises:
a charger casing with a basic body portion and a first lid, wherein the first lid conceals a first compartment provided in the basic body portion at least in part in a closed position of the first lid,
an electronics module that is inserted into the first compartment, wherein the electronics module comprises a power management circuitry and a charging circuitry that functionally connects power transfer elements provided in the charger to transfer electric power from a power source to the battery located in the hearing device, wherein the electronics module comprises a second compartment that is configured to receive a first portion of the hearing device, which first portion of the hearing device is configured to receive the electric power from the power transfer elements in an operating state of the charger,
wherein the basic body portion of the charger casing comprises a third compartment that is sized such that it can accommodate a second portion of the hearing device in a space-saving manner in an operating state of the charger, and
wherein the basic body portion is selected from a set of basic body portions comprising a first type of the basic body portion and a second type of the basic body portion, wherein the third compartment of the first type of the basic body portion is smaller in size than the third compartment of the second type of the basic body portion.

2. The charger according to claim 1, wherein the power source is a rechargeable battery provided in the charger.

3. The charger according to claim 2, wherein the power source is arranged in a fourth compartment provided in the basic body portion such that the power source is exchangeable, and wherein the basic body portion has a second lid arranged at its base portion that conceals the fourth compartment at least in part in a closed state of the second lid.

4. The charger according to claim 3, wherein the second lid is a sliding lid.

5. The charger according to claim 2, wherein the power source is electrically chargeable via a first charging terminal of the charger.

6. The charger according to claim 5, wherein the rechargeable power source is provided in the electronics module.

7. The charger according to claim 5, wherein the first charging terminal is provided in the electronics module such that it is accessible from outside the charger casing through a dedicated opening provided in a wall of the basic body portion of the charger casing.

8. The charger according to claim 5, wherein the power source is located in the basic body portion and electrically connected to the electronics module by way of a second charging terminal located at a bottom portion of the first compartment.

9. The charger according to claim 1, wherein the first lid is a hinged lid.

10. The charger according to claim 9, wherein the first lid is attached to the basic body portion.

11. The charger according to claim 9, wherein the first lid is attached to the electronics module.

12. The charger according to claim 1, wherein the electronics module is locked within the basic body portion after its insertion into the first compartment such that it is not falling out of the basic body portion unintentionally when the charger is positioned upside down and if the first lid is open.

13. The charger according to claim 1, wherein a volume of the third compartment is at least as large as a volume of the second compartment.

14. The charger according to claim 1, wherein a volume of the third compartment is at least 1.5 times as large as a volume of the second compartment.

15. The charger according to claim 1, wherein the first compartment is separated from the third compartment at least in part by a wall of the charger casing.
